(19) United States
(12) Patent Application Publication
(10) Pub. No.: US 2014/0289041 A1
(43) Pub. Date: Sep. 25, 2014

(54) TERMINAL DEVICE, COUPON SERVER DEVICE, COUPON-USING DEVICE, COUPON HISTORY-OF-USE SERVER DEVICE, AND COUPON SHARING SYSTEM

(71) Applicant: YAHOO JAPAN CORPORATION, Tokyo (JP)

(72) Inventor: Miho FUJII, Tokyo (JP)

(73) Assignee: YAHOO JAPAN CORPORATION, Tokyo (JP)

(21) Appl. No.: 14/204,859

(22) Filed: Mar. 11, 2014

(30) Foreign Application Priority Data
Mar. 22, 2013 (JP) 2013-059993

(51) Int. Cl. G06Q 30/02

(52) U.S. Cl. CPC G06Q 30/0251
USPC 705/14.49

(57) ABSTRACT

A terminal device includes a coupon file acquisition unit, a share-coupon file generation unit, a user ID holding unit, a first instruction unit, and a coupon file output unit. The coupon file acquisition unit is configured to acquire a sharable coupon file including a coupon information storing portion and a history-of-share information storing portion through a near-field wireless communication. The share-coupon file generation unit is configured to generate a coupon file to be output to be shared. The user ID holding unit is configured to hold a user ID. The first instruction unit is configured to instruct the share-coupon file generation unit to store a user ID in a history-of-share information storing portion in the generated coupon file. The coupon file output unit is configured to output the coupon file generated by the share-coupon file generation unit to share.

### CROSS-REFERENCE TO RELATED APPLICATIONS

The present application claims priority to and incorporates by reference the entire contents of Japanese Patent Application No. 2013-059993 filed in Japan on Mar. 22, 2013.

### BACKGROUND OF THE INVENTION

1. Field of the Invention

The present invention relates to a technology for distributing and managing electronic coupons which is accompanied by a history of share and a history of use of a sharable electronic coupon.

2. Description of the Related Art

Electronic coupons have been becoming widely used. Electronic coupons are distributed through the Internet and with which benefits such as discount are available. In order to more widely distribute electronic coupons, an electronic coupon system is proposed in which not only are electric coupons distributed through websites set up by advertisers and the like but also a user who obtained an electronic coupon can further redistribute the coupon to other users.

The electronic coupon system of Japanese Laid-open Patent Publication No. 2012-33098 can realize the object to widely distribute electronic coupons. However, it has no twist from the point of view of raising motivation of users to use electronic coupons.

### SUMMARY OF THE INVENTION

It is an object of the present invention to at least partially solve the problems in the conventional technology.

According to one aspect of an embodiment, a terminal device includes: a coupon file acquisition unit configured to acquire a sharable coupon file including a coupon information storing portion and a history-of-share information storing portion through a near-field wireless communication including a peer-to-peer wireless communication; a share-coupon file generation unit configured to generate a coupon file to be output to be shared, based on the acquired sharable coupon file; a user ID holding unit configured to hold a user ID; a first instruction unit configured to instruct the share-coupon file generation unit to store the held user ID in a history-of-share information storing portion in the coupon file when the share-coupon file generation unit generates the coupon file; and a coupon file output unit configured to output the coupon file generated by the share-coupon file generation unit for sharing through the peer-to-peer wireless communication.

According to another aspect of an embodiment, a coupon server device includes: a coupon-file output-request server reception unit configured to receive an output request for a sharable coupon file from a terminal device; and a coupon-file server output unit configured to output a coupon file to the terminal device in response to the received coupon file output request.

According to still another aspect of an embodiment, a coupon-using device includes: a coupon file receiving unit configured to receive a sharable coupon file from a terminal device to allow the sharable coupon file to be used; a validity determination unit configured to determine validity of a coupon file; and a history-of-use information output unit configured to acquire a user ID and to output the user ID while putting the user ID in association with a history-of-use of the coupon file.

According to still another aspect of an embodiment, a coupon history-of-use server device includes: a history-of-use information server acquisition unit configured to acquire history-of-use information of a coupon file while putting the history-of-use information of the coupon file in association with a user ID; a history-of-use information server accumulation unit configured to accumulate the acquired history-of-use information of the coupon file; and a history-of-use information server output unit configured to output the history-of-use information of the coupon file.

According to still another aspect of an embodiment, a method for operating a terminal device which holds a user ID and outputs a coupon file through a peer-to-peer wireless communication so that the coupon file is shared, the method includes: acquiring a sharable coupon file including a coupon information storing portion and a history-of-share information storing portion, through a near-field wireless communication including the peer-to-peer wireless communication; generating a coupon file to be output to be shared, based on the acquired sharable coupon file; and instructing to store the held user ID in the history-of-share information storing portion in the coupon file when the coupon file is generated.

According to still another aspect of an embodiment, a method for operating a coupon server device, the method includes: receiving an output request for a sharable coupon file from a terminal device; and outputting the shareable coupon file to the terminal device in response to the received coupon file output request.

According to still another aspect of an embodiment, a method for operating a coupon-using device, the method includes: receiving a sharable coupon file from a terminal device to allow the sharable coupon file to be used; determining validity of the sharable coupon file; and acquiring a user ID and outputting the user ID while putting the user ID in association with history-of-use information of the sharable coupon file.

According to still another aspect of an embodiment, a method for operating a coupon history-of-use server device, the method includes: acquiring history-of-use information of a coupon file while putting the history-of-use information of the coupon file in association with a user ID; accumulating the acquired history-of-use information of the coupon file; and outputting the history-of-use information of the coupon file.

According to still another aspect of an embodiment, a computer-readable recording medium having stored therein a program for making a terminal device perform: acquiring a sharable coupon file including a coupon information storing portion and a history-of-share information storing portion through a near-field wireless communication including a peer-to-peer wireless communication; generating, based on the acquired sharable coupon file, a coupon file to be output to be shared; holding a user ID; instructing to store the held user ID in the history-of-share information storing portion in the coupon file when the coupon file is generated; outputting the generated coupon file through the peer-to-peer wireless communication, to share, and using a coupon, based on coupon information of the acquired coupon file.

According to still another aspect of an embodiment, a program server device for distributing a program for making a terminal device perform: acquiring a sharable coupon file including a coupon information storing portion and a history-of-share information storing portion through a near-field wireless communication including a peer-to-peer wireless communication; generating, based on the acquired sharable coupon file, a coupon file to be output to be shared; holding a user ID; instructing to store the held terminal user ID in the history-of-share information storing portion in the coupon file when the coupon file is generated; outputting the generated coupon file through the peer-to-peer wireless communication, to share, and using a coupon, based on coupon information of the acquired coupon file.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of an aspect in which a terminal device of a first embodiment is used;

FIG. 2 is a block diagram illustrating an example of function blocks of the terminal device of the first embodiment;

FIG. 3 is a schematic diagram illustrating an example of coupon information stored in a coupon information storing unit;

FIGS. 4A and 43 are schematic diagrams illustrating an example of history-of-share information stored in a history-of-share information storing portion;

FIG. 5 is a schematic diagram illustrating an example of a hardware configuration of the terminal device of the first embodiment;

FIG. 6 is a flow chart illustrating an example of a process flow of the terminal device of the first embodiment;

FIG. 7 is a block diagram illustrating an example of function blocks of a terminal device of a second embodiment;

FIG. 8 is a schematic diagram illustrating an example of history-of-self-use information;

FIG. 9 is a block diagram illustrating an example of function blocks of a terminal device of a third embodiment;

FIG. 10 is a block diagram illustrating an example of function blocks of a terminal device of a fourth embodiment;

FIG. 11 is a block diagram illustrating an example of function blocks of a coupon server device;

FIG. 12 is a block diagram illustrating an example of a hardware configuration of a coupon server device;

FIG. 13 is a flow chart Illustrating an example of a process flow of a coupon server device;

FIG. 14 is a block diagram illustrating an example of function blocks of a coupon-using device;

FIG. 15 is a block diagram illustrating an example of a hardware configuration of a coupon-using device;

FIG. 16 is a flow chart illustrating an example of a process flow of a coupon-using device;

FIG. 17 is a block diagram illustrating an example of function blocks of a coupon history-of-use server device;

FIG. 18 is a black diagram illustrating an example of a hardware configuration of a coupon history-of-use server device; and

FIG. 19 is a flow chart showing an example of a process flow of a coupon history-of-use server device.

### DETAILED DESCRIPTION OF THE PREFERRED EMBODIMENTS

An embodiment of the present invention will be described below by using the accompanying drawings. Note that the present invention should not be limited to these embodiments at all, and can be practiced in various aspects without departing from the spirit of the invention.

### First Embodiment

### Overview

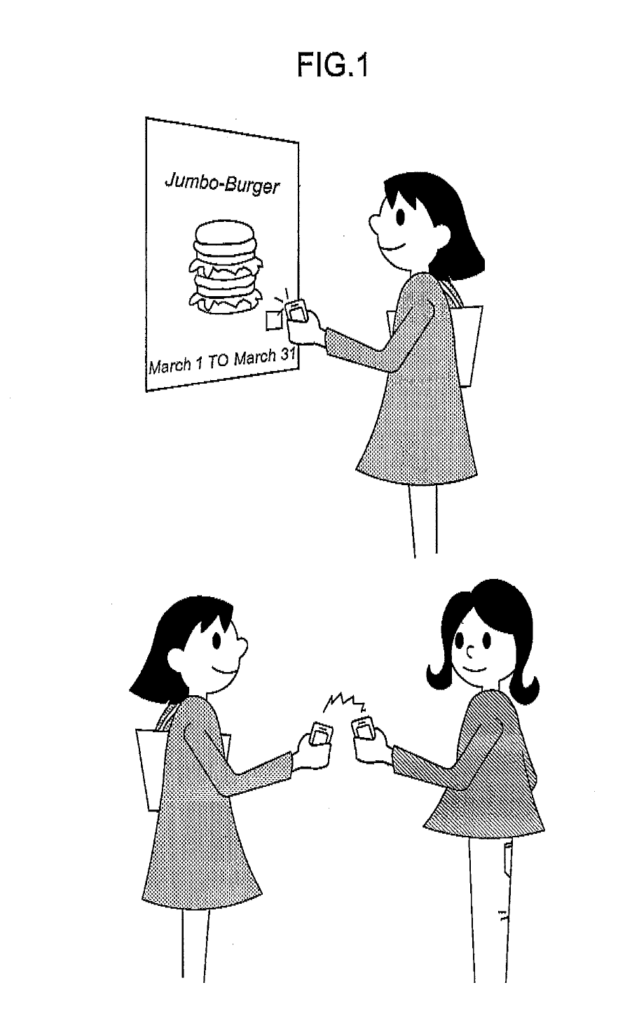

FIG. 1 is a schematic diagram illustrating an example of an aspect in which a terminal device of the present embodiment is used. First, the terminal device is capable of performing a near-field wireless communication. A standard of the near-field wireless communication includes the NFC (Near Field Communication), for example. The poster illustrated in the drawing is equipped with an IC tag based on the NFC, and by holding the terminal device over the IC tag, it is possible to acquire a coupon offering a benefit such as discount of goods shown in the poster. In addition, the user who acquired the coupon can output the coupon to a terminal device of other user so that the other user can acquire and share the coupon.

Further, a configuration may be made such that the coupon shared in this manner stores information about what type of user shares the coupon or stores information about how the user sharing the coupon used the coupon (to be described in detail in a second and following embodiments). For example, the user who shares the coupon gets in touch with those pieces of information and may become motivated to use himself the coupon having been used by other user having the same taste. As described above, when a coupon is made sharable, and a history of use and the like of the user sharing the coupon are made accessible, a motivation to use the coupon can be raised.

Functional Configuration

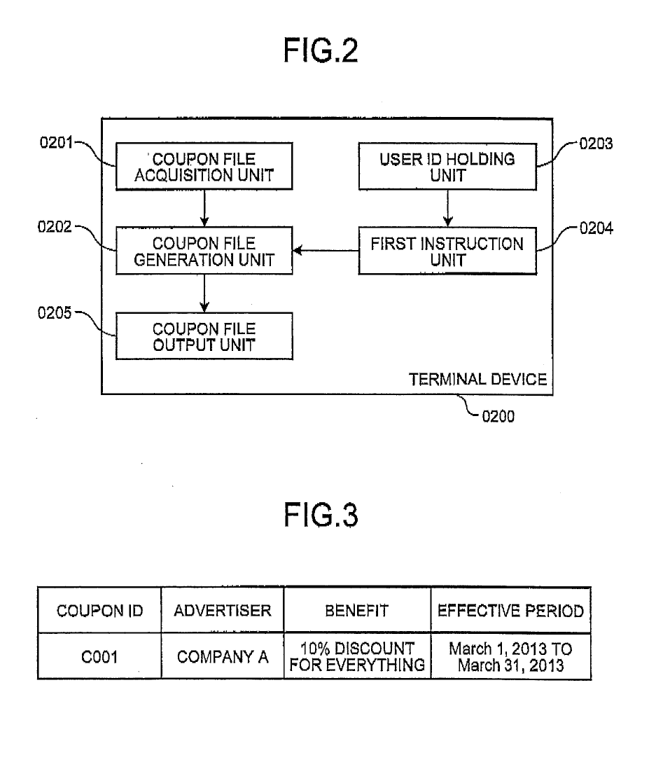

FIG. 2 is a block diagram illustrating an example of function blocks of the terminal device of the present embodiment. Note that the function blocks of this device to be described below can be realized by a combination of hardware and software. In particular, examples using a computer include a CPU (Central Processing Unit), a main memory, a bus, or a secondary storage device (a hard disk drive, a non-volatile memory, a storage medium including a CD and a DVD and a readout drive for the media), an input device to be used to input information, a printing equipment, a display, other hardware components such as an external peripheral device, or an interface for the external peripheral device, a communication interface, a driver program for controlling the hardware and other application programs, and an application for a user interface. Then, an operational process of the CPU according to a program expanded in the main memory causes data and the like having been input from the input device and other interfaces and held in the memory or the hard disk to be processed or accumulated, and generates instructions to control the above-mentioned hardware and software. Alternatively, the function blocks of this device may be realized by dedicated hardware.

Further, the present invention can be realized not only as a device but also as a method. Alternatively, a part of the present invention can be configured as software. Further, a program used to cause a computer to execute such software and a recording medium in which the program is recorded are obviously included in the technical scope of the present invention (this can be said throughout this specification).

As illustrated in FIG. 2, the terminal device 0200 of the present embodiment has a coupon file acquisition unit 0201, a coupon file generation unit 0202, a user ID holding unit 0203, a first instruction unit 0204, and a coupon file output unit 0205.

The coupon file acquisition unit 0201 has a function to obtain a sharable coupon file containing a coupon information storing portion and a history-of-share information storing portion through a near-field wireless communication including a peer-to-peer wireless communication. The near-field wireless communication performs a wireless communication in a very short distance such as some centimeters to one meter. A standard for the near-field wireless communication includes ISO/IEC 18092 and ISO/IEC 14443, for example.

The terminal device obtains the coupon file through such a near-field wireless communication. For example, as illustrated in FIG. 1, the coupon file is acquired by holding the terminal device over the poster equipped with the IC tag compatible with the standard for the near-field wireless communication, and the coupon file is sent or received between the terminal devices through the near-field wireless communication. Note that the peer-to-peer wireless communication represents a wireless communication performed between terminal devices without intermediary of a server, and the peer-to-peer wireless communication is realized by the near-field wireless communication. Thus, the coupon is shared while the users are actually in a close distance, and it can be understood that the process of sharing in this, way is retroactively secured. Therefore, for example, when a celebrity such as an idol is included in the sharing members, it is proved that the celebrity got close to some user to share the coupon in the process of sharing the coupon, whereby the motivation to use the coupon is raised, or a sense of affinity to the celebrity arises.

The coupon file of the present embodiment is configured to be sharable. The name of “coupon file” is given to add, besides to represent an inherent function as a coupon that a user can enjoy some benefits by using the coupon, a meaning of data set because a “history-of-share information” (to be described later) is stored therein. The term “share” means common ownership and means, for example, a benefit of a coupon can be enjoyed by a plurality of people. Further, since the coupon is shared through the peer-to-peer wireless communication using the near-field wireless communication without any intermediary server, the coupon is shared through a real interaction between users. Note that it does not matter whether the coupon file is obtained for free or for a fee.

The coupon file of the present embodiment contains the coupon information storing portion and the history-of-share information storing portion, in which coupon information and history-of-share information are stored, respectively. FIG. 3 is a schematic diagram illustrating an example of the coupon information stored in the coupon information storing portion. As illustrated in the drawing, for example, in the coupon denoted by reference numeral “C001”, there is stored various information as coupon information, which various information shows that the advertiser is “company A”, the offered benefit is “10% discount for all goods”, and the effective period of the coupon is “Mar. 1, 2013-Mar. 31, 2013”. Alternatively, other than the above case that a benefit can be enjoyable on a continuous basis, the benefit may be, for example, effective only on the date of an event such as a concert, and goods related to the guest artist can be purchased for half the price.

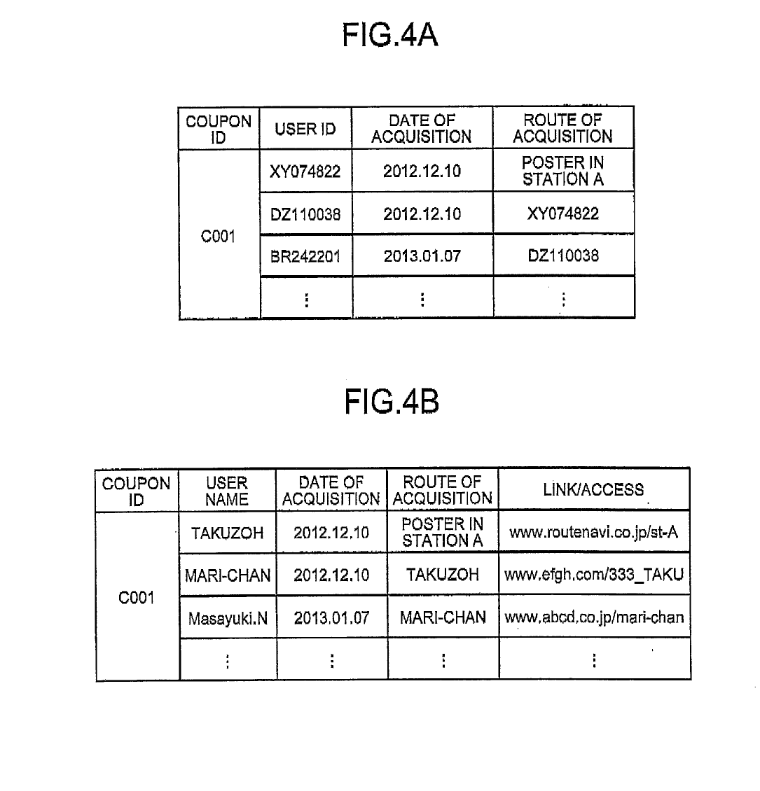

FIGS. 4A and 4B are schematic diagrams illustrating an example of the history-of-share information stored in the history-of-share information storing portion. As illustrated in FIG. 4A, for example, in the coupon denoted by reference numeral “C001”, there is stored information that the coupon was first acquired by the user identified by the ID “XY074822” on “Dec. 10, 2012”, from “the poster posted at the station A”. In this coupon, there is further stored information that the coupon was acquired on the same day from the user “XY074822” by the user “DZ110038”. There is further stored information that the coupon was acquired by the user “BR242201” on “Jan. 7, 2013”, from the user “DZ110038”. In this way, in the history-of-share information storing portion, the history-of-share information is stored, which shows that the coupon was acquired or shared through what route and by what user.

In addition, as illustrated in FIG. 4B, as the information representing the user, there can be displayed a name (a nickname, a handle name, and account name) such as “Takuzoh” or “Mari-chan” by which the concerned person can be identified to some extent. Then, with respect to the route through which the coupon was acquired, the information can be displayed, which shows the information on directions (map information, Navigation information, and the like) to the concerned place, link information to a blog or an SNS of the user whom the coupon was acquired from, and the like. Further, an image related to the sharing (a two-shot photo of the users sharing the coupon and the like) may be displayed. By showing such information, the user having newly shared the coupon can come in touch with information about what kind of situation the coupon was shared in, or about what kind of people share the coupon, whereby the motivation to use the coupon can be raised.

The coupon file generation unit 0202 has a function to generate a coupon file which will be output to be shared, based on an acquired sharable coupon file. As described later, the coupon file is output to be shared through the peer-to-peer wireless communication. For that purpose, the coupon file is generated to be in conformity with the standards for peer-to-peer wireless communications to be applied. Note that since the coupon file to be generated is output for sharing, a configuration may be made such that the coupon file is generated when the coupon file output unit performs output. In this case, when the effective period of the coupon to be output has only a short time left before expiration at the time when the coupon file is output, the coupon file may be generated with the coupon information modified such that at least one week effective period is left, for example.

The user ID holding unit 0203 has a function to hold the user ID. What corresponds to the user ID is, for example, a user account to make use of a website or an application, and is not limited to what can be associated with the terminal device.

The first instruction unit 0204 has a function to instruct a share-coupon file generation unit to store, when the share-coupon file generation unit generates a coupon file, the held user ID in the history-of-share information storing portion in the coupon file. The first instruction unit stores, for example, the user ID as illustrated in FIGS. 4A and 4B in the history-of-share information storing portion. At this time, as illustrated in the drawings, information such as acquisition dates and acquisition routes may be stored as well.

The coupon file output unit 0205 has a function to output, for sharing, the coupon file generated by the share-coupon file generation unit through the peer-to-peer wireless communication. The coupon file output unit performs coding of the coupon file in conformity with the protocol of the standards for peer-to-peer wireless communications to be applied for outputting the coupon file, and then outputs the coupon file for sharing.

The terminal device equipped with the above components has only to have at least a component capable of performing the near-field wireless communication including the peer-to-peer wireless communication, and examples include a portable telephone, a PHS (Personal Handy-phone System), a high-performance portable telephone (so-called a smartphone), a laptop PC, and a tablet PC.

Hardware Configuration

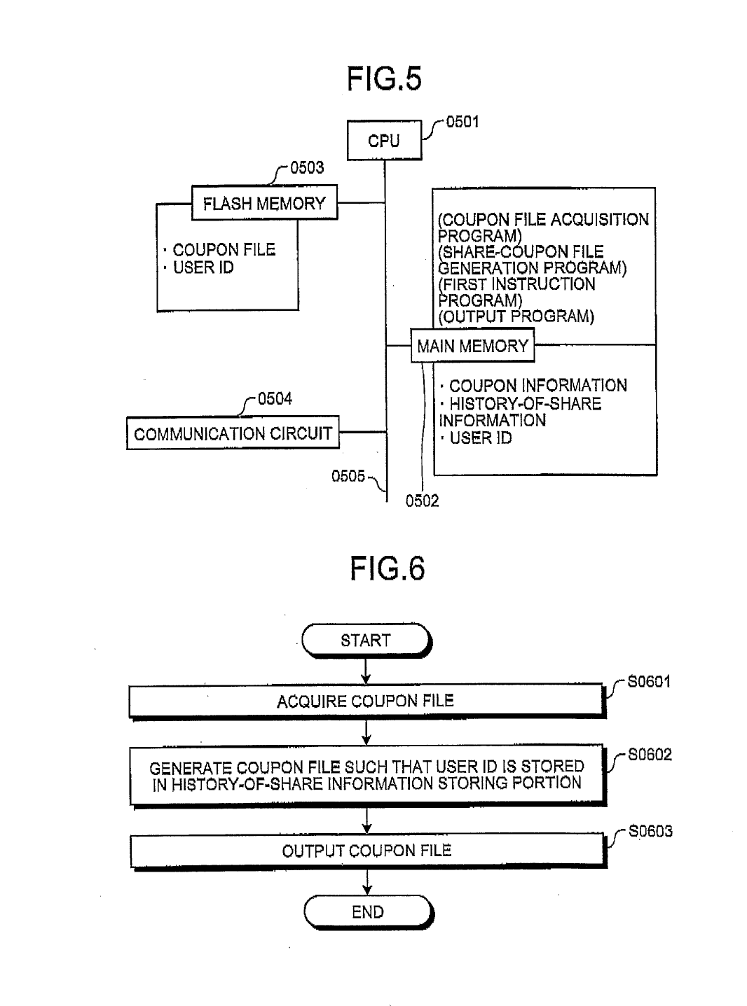

FIG. 5 is a schematic diagram illustrating an example of a configuration of the terminal device when the above functional structural components are realized as hardware. With reference to this drawing, a function of each hardware component related to the terminal device will be described.

As illustrated in the drawing, the terminal device is equipped with a CPU 0501 for performing various operational processes, a main memory 0502, a flash memory 0503, and a communication circuit 0504. In the flash memory, which is a non-volatile memory, there are stored various types of programs, and the CPU expands the various types of programs in the main memory and then performs the programs. The above-mentioned hardware components are connected to each other through a data communication path such as a system bus 0505 and perform the processes of transmitting, receiving, and processing information.

First, the CPU executes a coupon file acquisition program and then stores the acquired coupon file in the flash memory. Then, the CPU executes a share-coupon file generation program to read out the information of the stored history-of-share of the coupon file and store the information in the main memory at a predetermined address. Further, the CPU executes a first instruction program to read out the user ID held in the flash memory and stores the user ID in the main memory at a predetermined address. Then, the CPU stores the read-out user ID together with the history-of-share information in the history-of-share information storing portion, and then performs the process of generating the share-coupon file. Then, the CPU executes an output program, and when triggered by an instruction establishing a communication with another terminal device through the communication circuit, the CPU performs the process of outputting the generated share-coupon file to another terminal device.

Process Flow

FIG. 6 is a flow chart illustrating an example of a process flow in the terminal device of the present embodiment. Note that the below-described steps may be steps performed by the hardware components like the above-described computer, or may be process steps which are recorded in a medium and constitute a program for controlling a computer.

As illustrated in the drawing, first, the sharable coupon file is acquired through the near-field wireless communication including the peer-to-peer wireless communication (a coupon file acquisition step: S0601). Then, the coupon file is generated such that the user ID held in the flash memory and the like are stored in the history-of-share information storing portion of the acquired coupon file (a coupon file generation step: S0602). Then, the generated coupon file is output through the peer-to-peer wireless communication to be shared (a coupon file output step: S0603). Note that the coupon generation step may be performed so as to satisfy the standards for peer-to-peer wireless communications in such a manner that a step of generating the coupon file and a step of storing the held user ID in the history-of-share information storing portion of the coupon file are independently performed, and the order of processing the steps can be properly decided when the processes are performed.

Effect

According to the terminal device of the present embodiment, in the coupon file in which the coupon information and the history-of-share information are stored, the user ID of the user having acquired this coupon file is stored, and then the coupon file can be output to another terminal device, whereby by taking a look at the history-of-share information of the acquired coupon file, for example, the motivation to use the coupon can be raised.

### Second Embodiment

### Overview

The terminal device of the present embodiment is based on the terminal device of the first embodiment, and is configured to be able to store in the coupon file a history-of-use of a coupon. With this arrangement, it can be clear how the acquired coupon has been used, and the motivation to use a coupon can thus be raised.

Functional Configuration

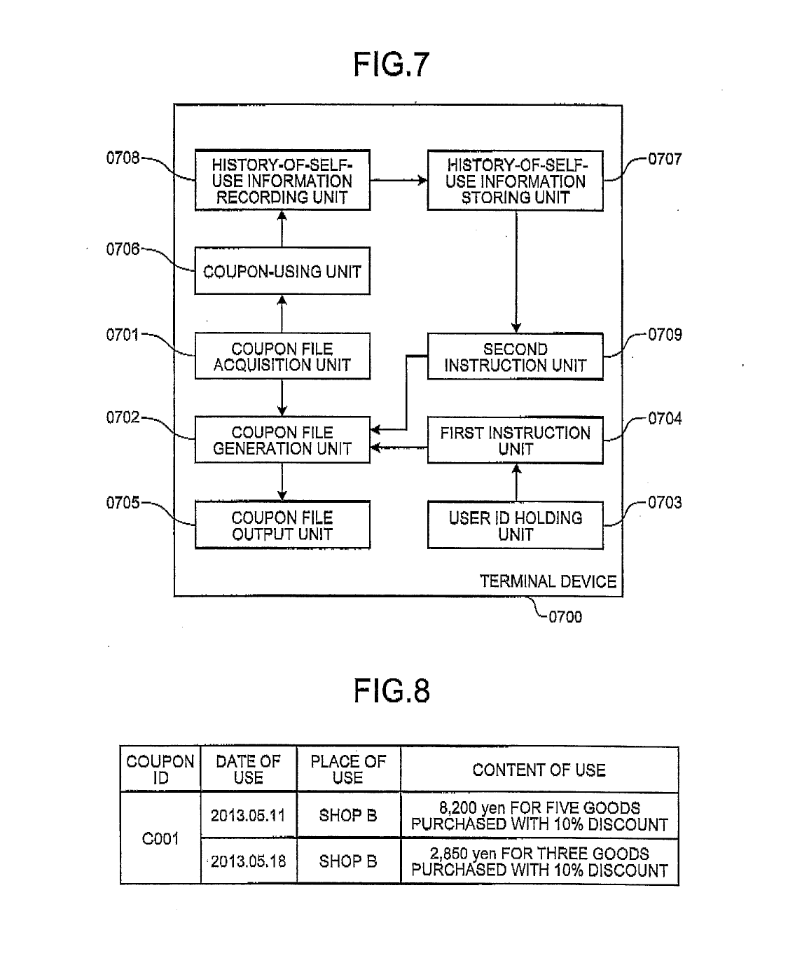

FIG. 7 is a block diagram illustrating an example of function blocks of a terminal device of the present embodiment. As illustrated in FIG. 7, a terminal device 0700 of the present embodiment has a coupon file acquisition unit 0701, a coupon file generation unit 0702, a user ID holding unit 0703, a first instruction unit 0704, a coupon file output unit 0705, and further a coupon-using unit 0706, a history-of-self-use information storing unit 0707, a history-of-self-use information recording unit 0708, and a second instruction unit 0709. Of the above components, descriptions about the components having been described in the first embodiment will not be repeated.

In the present embodiment, the coupon file further contains a history-of-use information storing portion. The history-of-use information is information showing how the coupon was used. For example, in a case of the coupon offering a benefit of “One Free Drink”, the information is a date and time or the shop when and where the coupon was used, and a name of the served free drink. Such history-of-use information is preferably stored in association with the ID of the user having used the coupon.

The coupon-using unit 0706 performs a function for using the coupon, based on the coupon information of the acquired coupon file. For example, by holding the terminal device over a reader/writer provided in a shop and equipped with the near-field wireless communication, it is shown that the terminal device has a coupon offering “One Free Drink”. Further, in a case that the terminal device has a display and the like, it may be shown that the terminal device has a coupon, by displaying the coupon.

The history-of-self-use information storing unit 0707 has a function to store therein the history-of-self-use information about the self-use of the coupon on the coupon-using unit. For example, a storing device such as a flash memory stores therein information such as a date and time or a shop and a mode of use (purchased five goods for 8,200 yen with 10% discount) when, where, and how the user used the coupon.

The history-of-self-use information recording unit 0708 has a function to record the history-of-self-use information in the history-of-self-use information storing unit, depending on self-use of the coupon on the coupon-using unit. For example, in a case that the above-mentioned user further purchased three goods for 2,850 yen with 10% discount by using the coupon, such mode of use is stored in the history-of-self-use information storing unit.

FIG. 8 is a schematic diagram illustrating an example of the history-of-self-use information stored in the history-of-self-use information storing unit. As illustrated in the drawing, the history-of-use information for “May 11, 2013”, and the history-of-use information for “May 18, 2013” are stored. That is to say, since the history-of-use information is recorded every time the coupon is used, the history-of-self-use information is accumulated in the history-of-self-use information storing unit. Further, a configuration may be made such that, as the history-of-self-use information, an image at the time of use and a comment after the use is stored, and in addition, link information to a blog or an SNS application in which such image and comment are stored. Since other users come in touch with the image and comment at the time of actual use, the motivation of the other users to use the coupon can be raised.

The second instruction unit 0709 has a function to instruct the share-coupon file generation unit so that when the share-coupon file generation unit generates a coupon file, the stored history-of-self-use information is recorded in the history-of-use information storing portion in the coupon file. According to the instruction of the second instruction unit, the coupon file is generated by the share-coupon file generation unit, which coupon file records the history-of-self-use information as illustrated in FIG. 8 in the history-of-use information storing portion of the coupon file. As described above, the history-of-use information of the user sharing the coupon file is accumulated in the concerned coupon file.

The coupon-using unit may be further equipped with a content-of-use modification unit configured to modify a content of use of the coupon, depending on the history-of-self-use information. For example, when the history-of-self-use reaches the number of use or an amount of payment for use having been previously set in the coupon information, the content of use is modified so that the discount rate already set is raised or a benefit is newly added. This can further raise the user's own motivation to use the coupon.

Further, the coupon-using unit may have a unit which counts the number of the users having shared the coupon file and modifies the content of use so that a benefit is newly given when the value of the count reaches a predetermined value. This raises many other users to share, thereby contributing spread of the coupon file.

Further, the terminal device may be equipped with a unit configured to hold the coupon file used in the coupon-using unit together with the coupon information, the history-of-share information, the history-of-self-use information, and the like. The coupon file finishes the role thereof when the coupon is acquired and used. However, the above-described pieces of information accompanying the coupon file contains various information such as information about the friend and the celebrity having shared together and information about the situation and the comment at the time of use and the like. Since a configuration is made to hold each coupon file containing those pieces of information, the function as an archive related to the coupon file can be played. Further, it can be easily identified whether one other user is a user with whom the user shared many coupons or in contrast a user with whom the user shared only a few coupons; thus, it is possible to know preferences of other users, whereby the coupon can play a role as a communication tool.

Hardware Components

The terminal device of the present embodiment can be realized to be similar to the hardware configuration described in the first embodiment, and in particular, regarding the generation of the coupon file, a second instruction program is executed to read out the history-of-self-use information stored in the flash memory, then to perform a process for writing the read-out history-of-self-use information in the history-of-use information storing portion of the coupon file.

Process Flow

The process flow of the terminal device of the present embodiment is the same as the process flow of the terminal device of the first embodiment except that the following two steps are performed, one of which is performed, when the self-use of the coupon occurs, to store the history-of-self-use information in the history-of-self-use information storing unit, and the other of which is performed, when generating the coupon file, to record the history-of-self-use information which is stored in the history-of-self-use information storing unit in the history-of-use information storing portion of the coupon file.

Effect

According to the terminal device of the present embodiment, since the history-of-self-use information of an acquired coupon file is stored in the history-of-use information storing portion of the coupon file, the history-of-use information of the user who shared and used the coupon is accumulated in the coupon file.

### Third Embodiment

### Overview

The terminal device of the present embodiment is based on the first or second embodiment, and is configured to store the information about the history-of-use, on the destination of sharing, of the coupon for the coupon file having been output from the coupon file output unit of the terminal device, and is also configured to be able to display the stored history-of-use information.

Functional Configuration

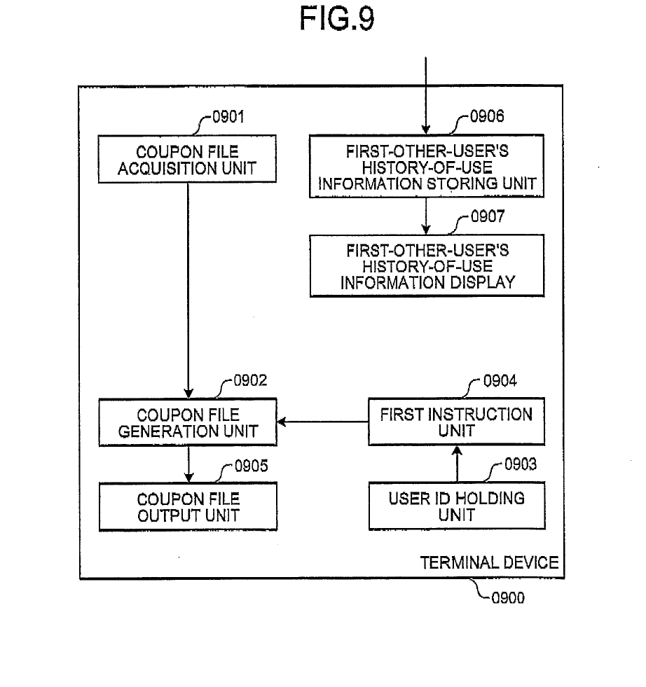

FIG. 9 is a block diagram illustrating an example of function blocks of the terminal device of the present embodiment. As illustrated in FIG. 9, a terminal device 0900 of the present embodiment has a coupon file acquisition unit 0901, a coupon file generation unit 0902, a user ID holding unit 0903, a first instruction unit 0904, a coupon file output unit 0905, and further a first-other-user's history-of-use information storing unit 0906, and a first-other-user's history-of-use information display 0907. Note that the coupon-using unit and the like specifically described in a second embodiment are not illustrated in the drawings. Of the above-mentioned components, the components already described in the first embodiment will not be described again.

The first-other-user's history-of-use information storing unit 0906 has a function to store first-other-user's history-of-use information, which is a history of use, of other user, of the coupon file having been output from the coupon file output unit. In storing the first-other-user's history-of-use information, the first-other-user's history-of-use information needs to be acquired first. As a configuration for that purpose, for example, a configuration may be conceived such that an email address and the like are written in the history-of-self-use information to be stored in the history-of-use information storing portion of the coupon file to be output from the coupon file output unit, and there is recorded a program for sending the history-of-use information of the coupon to the email address when triggered by other user using the concerned coupon. Further, a configuration may be made such that a server device or the like for gathering the history of use of the coupon file is required to provide the history-of-use information of other user, and the history-of-use information of other user from the concerned server device can be acquired in response to the request. Note that a configuration may be made to contain as the first-other-user's history-of-use information the history-of-use information not only of other user to whom the coupon file is output but also of still other user when the other user outputs the coupon file to the still other user. A first-other-user's history-of-use information storing unit stores the first-other-user's history-of-use information acquired as described above in the storing device such as a flash memory.

The first-other-user's history-of-use information display 0907 has a function to display the stored first-other-user's history-of-use information. When information about the use of coupon (an image and a comment at the time of use, map information of the place of use, and the like) is accompanying the first-other-user's history-of-use information, such information may be also displayed.

Further, a configuration may be made such that when the coupon-using unit having a content-of-use modification unit is provided, the content of use of the coupon is modified depending on the acquired first-other-user's history-of-use information. For example, in response to the use of the coupon by other user reaching a predetermined number or amount of money, the content of a benefit is raised or a benefit is newly added. Further, in the case that the effective period for self-use has expired, the content may be modified so that the coupon is again effective for a predetermined period by being triggered when the first-other-user's history-of-use information is acquired.

Hardware Components

In the terminal device of the present embodiment, the functional components except the first-other-user's history-of-use information storing unit and the first-other-user's history-of-use information display are realized to be similar to the hardware components of the first or second embodiment. Here, the first-other-user's history-of-use information storing unit receives an email through the communication circuit, the CPU executes a first user history-of-use information storing program stored in the flash memory, the first-other-user's history-of-use information is read out from the received email, and the read-out first-other-user's history-of-use information is stored in the flash memory. Then, the CPU executes a first-other-user's history-of-use display program to read out the stored first-other-user's history-of-use information and to display the read-out information on a display device such as a display.

Process Flow

The process flow of the terminal device of the present embodiment is Similar to the process flow of the terminal device of the first or second embodiment except that the process flow includes the step of storing the first-other-user's history-of-use information and the step of displaying the stored first-other-user's history-of-use information.

Effect

With the terminal device of the present embodiment, it can be seen how the coupon file having been output was used by other user; thus, not only the motivation to use the own coupon but also the motivation to output the coupon for sharing can be raised. This can facilitate use and distribution of the coupon file.

### Fourth Embodiment

### Overview

The terminal device of the present embodiment is a terminal device which is based on any of the first to third embodiments, and which can store the history-of-use information of other user contained in the coupon file acquired from another terminal through the peer-to-peer wireless communication or acquired from the poster having the IC tag capable of the near-field wireless communication, and can display the history-of-use information.

Functional Configuration

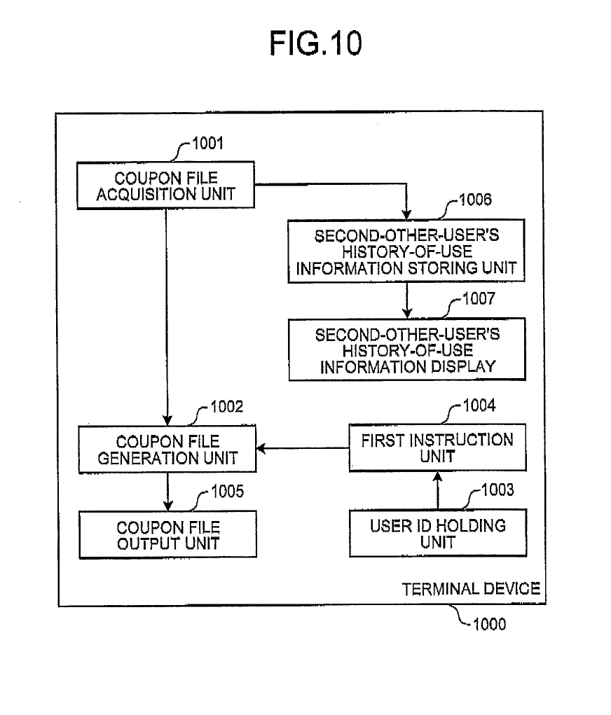

FIG. 10 is a block diagram illustrating an example of function blocks of the terminal device of the present embodiment. As illustrated in FIG. 10, a terminal device 1000 of the present embodiment has a coupon file acquisition unit 1001, a coupon file generation unit 1002, a user ID holding unit 1003, a first instruction unit 1004, a coupon file output unit 1005, and further a second-other-user's history-of-use information storing unit 1006, and a second-other-user's history-of-use information display 1007. The components specifically described in the second and third embodiments are not illustrated in the drawings. Further, of the above-mentioned components, the components already described in the first to third embodiments will not be described again.

The second-other-user's history-of-use information storing unit 1006 has a function to store, besides the coupon file acquired in the coupon file acquisition unit, the second-other-user's history-of-use information, which is the history of use of the other user. The coupon file acquired in the coupon file acquisition unit is the coupon file having been output from the terminal device having the coupon file output unit through the peer-to-peer wireless communication or the coupon file acquired from a reader/writer using the near-field wireless communication such as a poster having an IC tag equipped with the near-field wireless communication.

The second-other-user's history-of-use information may contain, when the coupon file contains the history-of-use information of users other than the user of the output-source terminal device, the history-of-use information of such users in addition to the coupon history-of-use information of the user of the output-source terminal device. Further, it is preferable that, in the second-other-user's history-of-use information, the user ID of the user of the output-source terminal device and the like and the coupon history-of-use information are associated with each other. Much the same is true on the history-of-use information of the user other than the user of the output-source terminal device.

Further, in the case that the coupon file is acquired from the reader/writer and the like using the near-field wireless communication such as the poster having the IC tag equipped with the near-field wireless communication, the history-of-use information of other user who has already shared the coupon file is sometimes stored. Even in the case of not using the direct intermediary of the terminal device of other user as described above, when the obtained coupon file contains history-of-use information of other user, such history-of-use information is also stored as the second-other-user's history-of-use information.

The second-other-user's history-of-use information display 1007 has a function to display the stored second-other-user's history-of-use information. The displayed second-other-user's history-of-use information can raise the motivation, of the user who comes in touch with such information, to use that coupon. Further, when displaying the second-other-user's history-of-use information, a configuration may be made such that there are pieces of additionally displayed information such as shops in which the coupon is available, directions to the shops, and the like, depending on the user's requirement.

When the terminal device of the present embodiment has the content-of-use modification unit, the content-of-use modification unit may be made to not only modify the content of use of the coupon depending only on the history-of-self-use information as described in the second embodiment but also to modify the content of use of the coupon depending on at least any one of the history-of-self-use information, the first-other-user's history-of-use information, and second-other-user's history-of-use information. With this configuration, the users sharing the coupon can raise each other's motivation to use the coupon.

Hardware Components

The terminal device of the present embodiment can be realized based on the hardware configuration described in the first to third embodiments by adding the display and the like to the configuration and by executing a second-other-user's history-of-use information storing program and a second-other-user's history-of-use display program stored in the flash memory. Therefore, no description will be made here.

Process Flow

The process flow of the terminal device of the present embodiment is the same as the process flow of the terminal device of any one of the first to third embodiments except that process contains the step of storing the second-other-user's history-of-use information and the step of displaying the stored second-other-user's history-of-use information.

Effect

Since the terminal device of the present embodiment displays other user's history-of-use information contained in the coupon file and the information is shown to a user, the motivation of the user to use the coupon can be raised.

### Fifth Embodiment

### Overview

The present embodiment relates to a coupon server device for outputting the coupon file to the terminal device, a coupon-using device for making the coupon file be used, and a coupon history-of-use server device for accumulating and outputting the history-of-use information of the coupon file, and a coupon sharing system made up of these devices and the terminal device.

Configuration

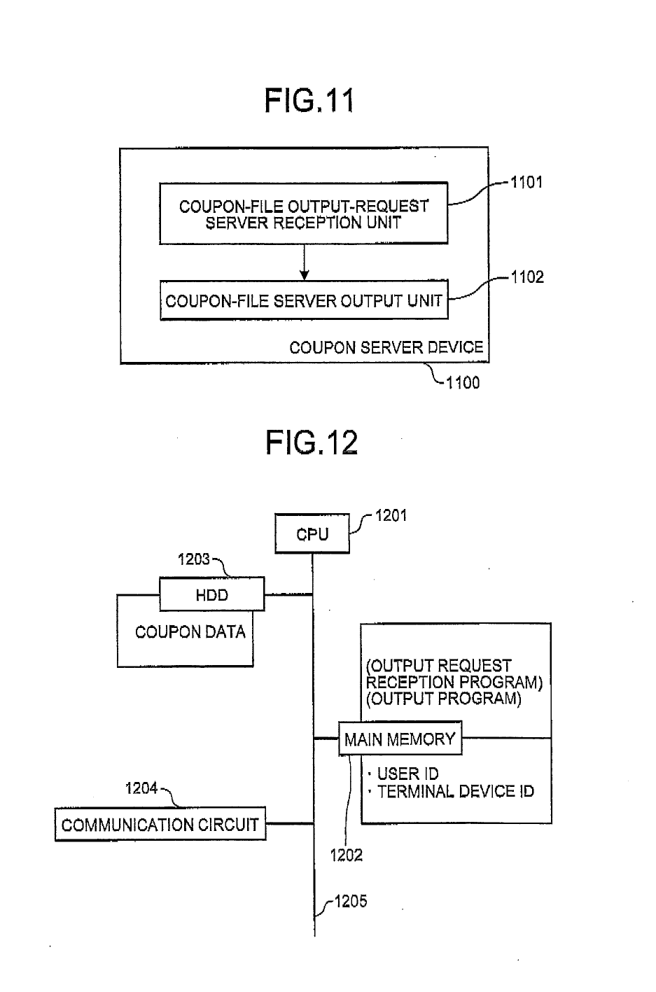

FIG. 11 is a block diagram illustrating an example of function blocks of the coupon server device. As illustrated in the drawing, a coupon server device 1100 has a coupon-file output-request server reception unit 1101 and a coupon-file server output unit 1102.

The coupon-file output-request server reception unit 1101 has a function to receive an output request for a sharable coupon file from the terminal device. For example, by holding up the terminal device, the output is received through the near-field wireless communication. As illustrated in FIG. 1, the IC tag may be attached to a bulletin such as a poster to perform the reception, or the reception may be performed by holding the terminal device over the reader/writer installed in a shop or the like.

The coupon-file server output unit 1102 has a function to output the coupon file to the terminal device, in response to the received coupon file output request. The coupon file is output through the near-field wireless communication and the like in the similar manner to the reception of the output request. Since the coupon file is output in response to the output request from the terminal device, the user can acquire the required coupon file by one action such as holding up the terminal device.

FIG. 12 is a schematic diagram illustrating an example of a configuration of the coupon server device realized as hardware. As illustrated in the drawing, the coupon server device is equipped with a CPU 1201 for executing various types of operational processes, a main memory 1202, an HID 1203, and a communication circuit 1204. In the HDD, there is stored various types of programs, and the CPU expands the various types of programs in the main memory and then executes the programs. The above-described hardware components are connected to each other by a data communication path such as a system bus 1205 to transmit, receive, and process information.

First, the CPU executes the output request reception program to receive the output request from the terminal device and then stores the ID and the user ID of the terminal device in a predetermined address. Then, the CPU executes the output program to read out the required coupon data from the HDD and output the coupon data to the terminal device.

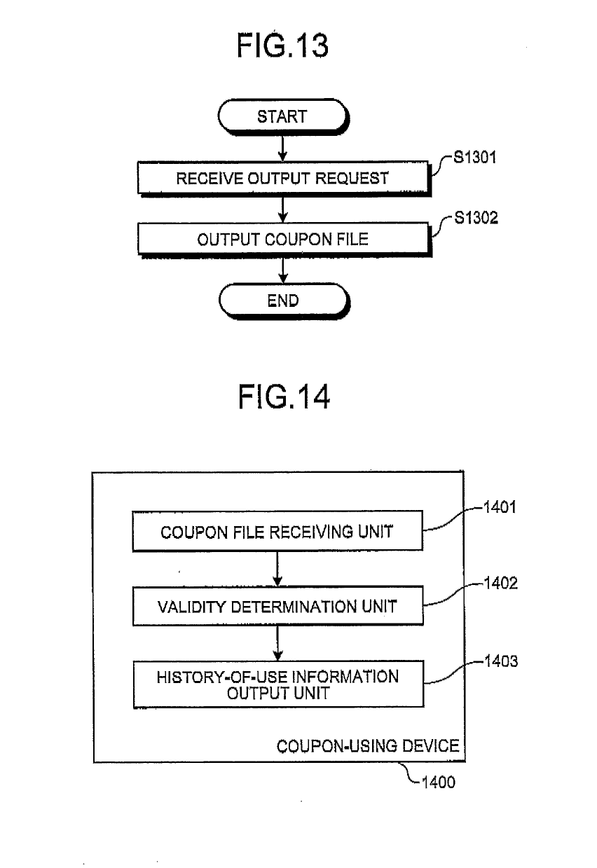

Further, a process flow of the coupon server device is illustrated in FIG. 13, and an output request for a sharable coupon file is first received from the portable terminal (S1301). Then, in response to the received coupon file output request, the coupon file is output to the terminal device (S1302).

FIG. 14 is a block diagram illustrating an example of function blocks of the coupon-using device. As illustrated in the drawing, the coupon-using device 1400 has a coupon file receiving unit 1401, a validity determination unit 1402, and a history-of-use information output unit 1403.

The coupon file receiving unit 1401 has a function to receive the sharable coupon file from the terminal device to allow the sharable coupon file to be used. The coupon file is received through the near-field wireless communication and the like.

The validity determination unit 1402 has a function to determine the validity of the coupon file. In the determination of the validity of the coupon file, it is determined, for example, whether the coupon is within the effective period or whether the user has an authority to use the coupon. Such a determination may be performed through the communication with the above-described coupon server device.

The history-of-use information output unit 1403 has a function to acquire the user ID and associate the user ID with the history-of-use information of the coupon file to output. An output destination may be the terminal device being used or the coupon server device described above.

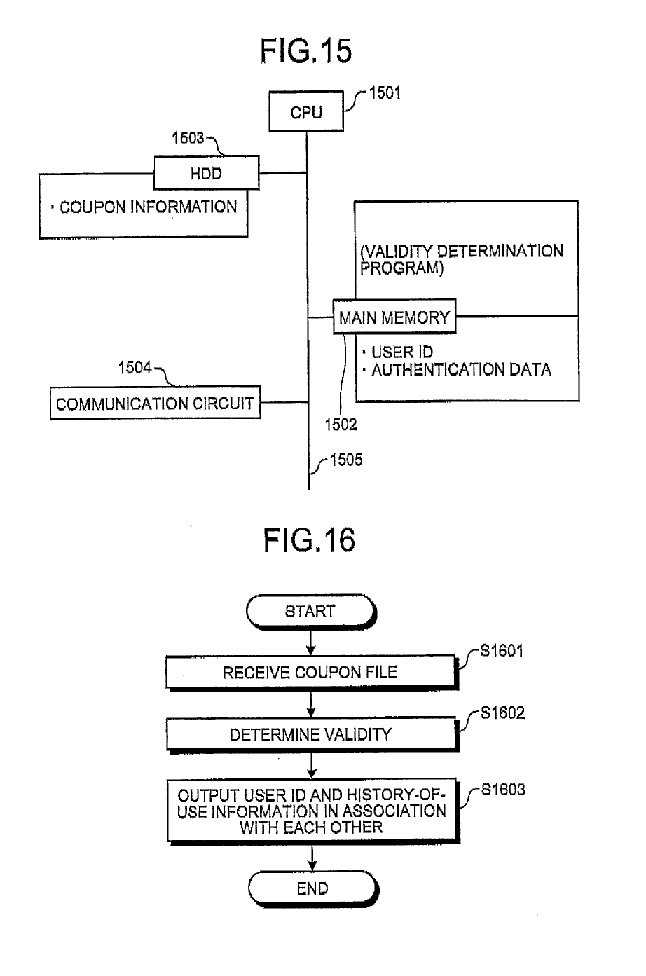

FIG. 15 is a schematic diagram illustrating an example of the configuration of the coupon-using device realized as hardware. As illustrated in the drawing, the coupon-using device is equipped with a CPU 1501 for executing various types of operational processes, a main memory 1502, an HEM 1503, and a communication circuit 1504. In the HDD, there are stored various types of programs, and the CPU expands the various types of programs in the main memory and then executes the programs. The above-described hardware components are connected to each other by a data communication path such as a system bus 1505 to transmit, receive, and process information.

The CPU first executes a validity determination program to read out the user ID and authentication data and performs a process to determine the validity of the received coupon file. Further, if needed, the CPU transmits and receives information for determining the validity with another device, for example, the coupon server device through the communication circuit. Then, the CPU performs a process to output the history-of-use information associated with the user ID.

Further, a process flow of the coupon-using device is illustrated in FIG. 16, and the sharable coupon file is first received from the terminal device to allow the sharable coupon file to be used (S1601). Then, the validity of the received coupon file is determined (S1602). Then, the user ID is acquired, is put in association with the history-of-use information of the coupon file, and is output (S1603).

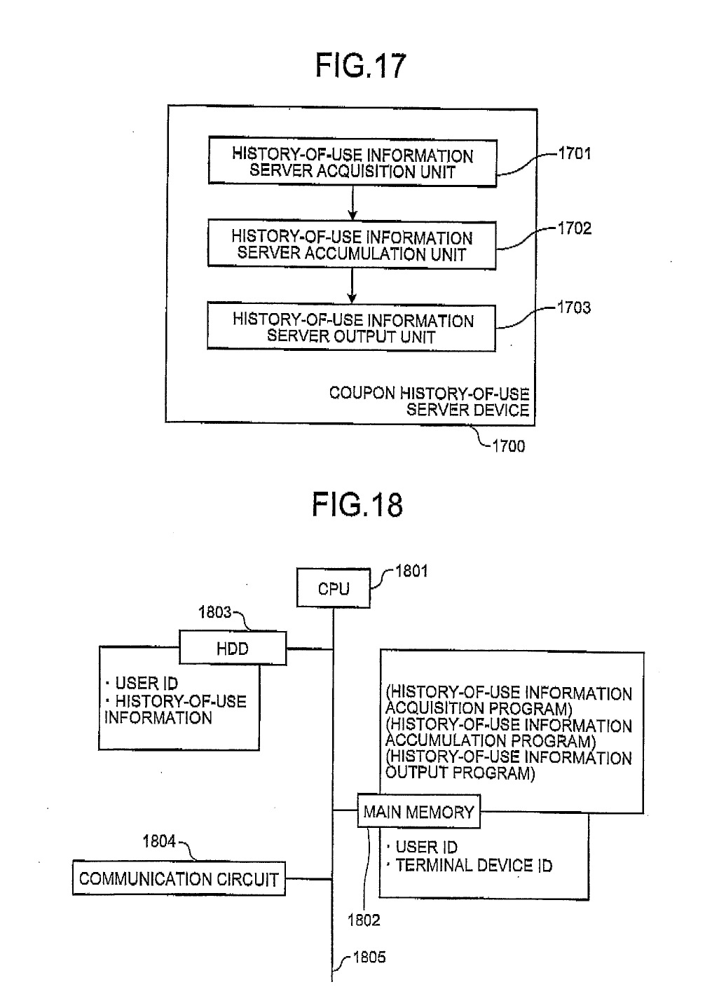

FIG. 17 is a block diagram illustrating an example of function blocks of the coupon history-of-use server device. As illustrated in the drawing, the coupon history-of-use server device 1700 has a history-of-use information server acquisition unit 1701, a history-of-use information server accumulation unit 1702, and a history-of-use information server output unit 1703.

The history-of-use information server acquisition unit 1701 has a function to acquire the history-of-use information of the coupon file while putting the history-of-use information of the coupon file in association with the user ID. The history-of-use information may be acquired from the terminal device or may be acquired from the coupon-using device. When the history-of-use information is accompanied by information such as an image at the time of use or a comment after the use or link information to a blog or an SNS application in which such image or comment is posted, such information is acquired being put in association with the user ID.

The history-of-use information server accumulation unit 1702 has a function to accumulate the acquired history-of-use information of the coupon file. When addition or modification of the above-described accompanying information occurs to the history-of-use information of the coupon file, and the history-of-use server acquisition unit has acquired such information, such information also may be accumulated or updated as needed.

The history-of-use information server output unit 1703 has a function to output the history-of-use information of the coupon file. For example, when an acquisition request for the history-of-use information of the coupon file and the like is received from the terminal device, the predetermined history-of-use information is output in response to the request. Further, the information may be output in response to the output request from the coupon server device. Note that a configuration may be made such that a unit is provided to determine the validity of the output request such as whether the output request has authority.

FIG. 18 is a schematic diagram illustrating an example of the configuration of the coupon history-of-use server device realized as hardware. As illustrated in the drawing, the coupon history-of-use server device is equipped with a CPU 1801 for executing various types of operational processes, a main memory 1802, an HDD 1803, and a communication circuit 1804. In the HDD, there is stored various types of programs, the CPU expands the various types of programs in the main memory and then executes the programs. The above-described hardware components are connected to each other by a data communication path such as a system bus 1805 to transmit, receive, and process information.

The CPU first executes a history-of-use information acquisition program to receive the history-of-use information from the terminal device, the coupon-using device, or the like and acquires the history-of-use information while putting the history-of-use information in association with its user ID. Then, the CPU executes the history-of-use information storing program to perform a process to store the history-of-use information in a predetermined address in the HDD. Then, when triggered by an output request from the terminal device, the coupon server device, and the like, the CPU executes a history-of-use information output program to read out the required history-of-use information from the HDD and to output the history-of-use information to the source of the output request such as the terminal device.

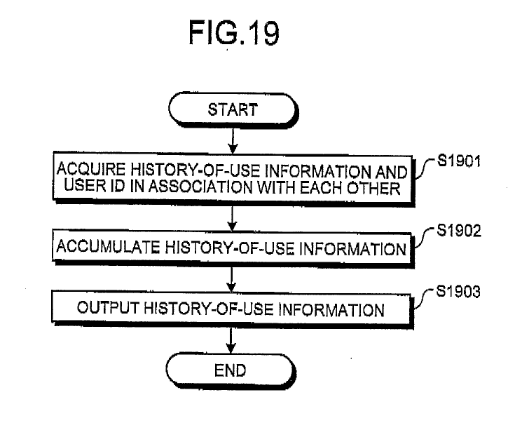

Further, a process flow of the coupon history-of-use server device is illustrated in FIG. 19, and the history-of-use information of the coupon file is first acquired in association with the user ID (S1901). Then, the acquired history-of-use information of the coupon file is accumulated (S1902). Then, in response to the output request from the terminal device, the coupon server device, and the like, the history-of-use information of the coupon file is output (S1503).

Effect

With the coupon sharing system constituted by at least one or more of the devices of the present embodiment and the terminal device, a motivation of a user to use a coupon can be raised, and the effect of advertising and promotion for the advertiser can be improved.

According to an embodiment, a terminal device and the like can be provided in which a history of share and a history of use are made to accompany a coupon, and such coupon can be given and taken between terminal devices without intermediary of a server. The coupon is shared by friends or celebrities in some cases, and the sight of such other users' history of use raises motivation to use the coupon.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
a coupon file acquisition unit configured to acquire a sharable coupon file including a coupon information storing portion and a history-of-share information storing portion through a near-field wireless communication including a peer-to-peer wireless communication;
a share-coupon file generation unit configured to generate a coupon file to be output to be shared, based on the acquired sharable coupon file;
a user ID holding unit configured to hold a user ID;
a first instruction unit configured to instruct the share-coupon file generation unit to store the held user ID in a history-of-share information storing portion in the coupon file when the share-coupon file generation unit generates the coupon file; and
a coupon file output unit configured to output the coupon file generated by the share-coupon file generation unit for sharing through the peer-to-peer wireless communication.

2. The terminal device according to claim 1, wherein the coupon file further includes a history-of-use information storing portion, and wherein the terminal device comprises:
a coupon-using unit configured to use a coupon, based on coupon information of the acquired coupon file;
a history-of-self-use information storing unit configured to store therein history-of-self-use information of a coupon by the coupon-using unit;
a history-of-self-use information recording unit configured to record the history-of-self-use information in the history-of-self-use information storing unit in response to self-use of a coupon by the coupon-using unit, and
a second instruction unit configured to instruct the share-coupon file generation unit to record, when the share-coupon file generation unit generates a coupon file, the stored history-of-self-use information in the history-of-use information storing portion in the coupon file.

3. The terminal device according to claim 1, further comprising:
a first-other-user's history-of-use information storing unit configured to store first-other-user's history-of-use information which is a history of use, of other user, of the coupon file having been output from the coupon file output unit; and
a first-other-user's history-of-use information display configured to display the stored first-other-user's history-of-use information.

4. The terminal device according to claim 1, further comprising:
a second-other-user's history-of-use information storing unit configured to store second-other-user's history-of-use information which is a history of use, of other user, of the coupon file acquired by the coupon file acquisition unit;
a second-other-user's history-of-use information display configured to display the stored second-other-user's history-of-use information.

5. The terminal device according to claim 4, wherein the coupon-using unit includes:
a content-of-use modification unit configured to modify a content of use of a coupon, depending on at least any one of the history-of-self-use information, the first-other-user's history-of-use information, and the second-other-user's history-of-use information.

6. A coupon sharing system comprising:
the terminal device according to claim 1; and
a coupon server device that outputs the sharable coupon file to the terminal device.

7. A coupon server device comprising:
a coupon-file output-request server reception unit configured to receive an output request for a sharable coupon file from a terminal device; and
a coupon-file server output unit configured to output a coupon file to the terminal device in response to the received coupon file output request.

8. A coupon sharing system comprising:
the coupon server device according to claim 7; and
the terminal device that sends the output request for the sharable coupon file.

9. A coupon-using device comprising:
a coupon file receiving unit configured to receive a sharable coupon file from a terminal device to allow the sharable coupon file to be used;
a validity determination unit configured to determine validity of a coupon file; and
a history-of-use information output unit configured to acquire a user ID and to output the user ID while putting the user ID in association with a history-of-use of the coupon file.

10. A coupon sharing system comprising:
the coupon-using device according to claim 9; and
the terminal device that sends the sharable coupon file to the coupon-using device.

11. A coupon history-of-use server device comprising:
a history-of-use information server acquisition unit configured to acquire history-of-use information of a coupon file while putting the history-of-use information of the coupon file in association with a user ID;
a history-of-use information server accumulation unit configured to accumulate the acquired history-of-use information of the coupon file; and
a history-of-use information server output unit configured to output the history-of-use information of the coupon file.

12. A coupon sharing system comprising:
the coupon history-of-use server device according to claim 11; and
at least one of a terminal device and a coupon server device that receives the history-of-use information output by the history-of-use information server output unit.

13. A method for operating a terminal device which holds a user ID and outputs a coupon file through a peer-to-peer wireless communication so that the coupon file is shared, the method comprising:
acquiring a sharable coupon file including a coupon information storing portion and a history-of-share information storing portion, through a near-field wireless communication including the peer-to-peer wireless communication;
generating a coupon file to be output to be shared, based on the acquired sharable coupon file; and
instructing to store the held user ID in the history-of-share information storing portion in the coupon file when the coupon file is generated.

14. A method for operating a coupon server device, the method comprising:
receiving an output request for a sharable coupon file from a terminal device; and
outputting the shareable coupon file to the terminal device in response to the received coupon file output request.

15. A method for operating a coupon-using device, the method comprising:
receiving a sharable coupon file from a terminal device to allow the sharable coupon file to be used;
determining validity of the sharable coupon file; and
acquiring a user ID and outputting the user ID while putting the user ID in association with history-of-use information of the sharable coupon file.

16. A method for operating a coupon history-of-use server device, the method comprising:
acquiring history-of-use information of a coupon file while putting the history-of-use information of the coupon file in association with a user ID;
accumulating the acquired history-of-use information of the coupon file; and
outputting the history-of-use information of the coupon file.

17. A computer-readable recording medium having stored therein a program for making a terminal device perform:
acquiring a sharable coupon file including a coupon information storing portion and a history-of-share information storing portion through a near-field wireless communication including a peer-to-peer wireless communication;
generating, based on the acquired sharable coupon file, a coupon file to be output to be shared;
holding a user ID;
instructing to store the held user ID in the history-of-share information storing portion in the coupon file when the coupon file is generated;
outputting the generated coupon file through the peer-to-peer wireless communication, to share, and
using a coupon, based on coupon information of the acquired coupon file.

18. A program server device for distributing a program for making a terminal device perform:
acquiring a sharable coupon file including a coupon information storing portion and a history-of-share information storing portion through a near-field wireless communication including a peer-to-peer wireless communication;
generating, based on the acquired sharable coupon file, a coupon file to be output to be shared;
holding a user ID;
instructing to store the held terminal user ID in the history-of-share information storing portion in the coupon file when the coupon file is generated;
outputting the generated coupon file through the peer-to-peer wireless communication, to share, and
using a coupon, based on coupon information of the acquired coupon file.
